(19) United States
(12) Patent Application Publication
(10) Pub. No.: US 2007/0195661 A1
(43) Pub. Date: Aug. 23, 2007

(54) Power down apparatus for optical data drive

(75) Inventor: Jeroen Arnoldus Leonardus Johannes Raaymakers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,830

(22) PCT Filed: Mar. 31, 2005
(86) PCT No.: PCT/IB05/51079

§ 371 Date: Oct. 11, 2006

(30) Foreign Application Priority Data
Apr. 14, 2004 (EP) 04101523.1

(51) Int. Cl. G11B 7/00

(52) U.S. Cl. 369/44.32; 369/53.19; 369/44.29

(57) ABSTRACT

In an optical drive system, a “power down state” with a fast “leave power down” timing is provided. In order to meet these timing requirements, when the controller switches the system from a normal power supply mode to a power save mode, the focus and radial servo loops are kept closed, and only the tilt is reduced to zero, i.e. the tilt compensation mechanism is temporarily disabled. In order to ensure a relatively speedy commencement of a read/record operation from the power down mode (and to avoid drifting away from the readout spot to the outer radius of the disc), the system is arranged to cause the radiation spot to jump back a track every time it approaches the sector address at which the pause mode was initiated. The sledge motor controller is disabled and the average radial actuator voltage (i.e. the average voltage applied to the radial actuator controlled by the radial servo loop) is used to determine when to jump back. Thus, an address readout function is no longer required.

This invention relates generally to power down apparatus for an optical disc drive and, more particularly, to a method and apparatus for effecting a power down function in an optical data drive, especially during a pause mode thereof, so as to minimise power consumption without compromising reproducing or recording speeds. Examples of the storage media used in such an optical data drive are, for instance, CD-ROM, CD-R, CD-RW, DVD, Blu Ray etc. In these examples, the optical storage medium has the shape of a disc.

Optical data storage systems provide a means for storing large quantities of data on a disc. As is well known in the art, an optical disc comprises at least one track which is capable of containing data written therein. The disc may be embodied so as to be a read-only disc: the disc is manufactured with data recorded in the track, and this data can only be read from the disc. However, writeable optical discs, allowing a user to record data on a disc, are also known; in this case, a disc will normally be manufactured as a blank disc, i.e. a disc having a track structure but without data recorded in the track. Similarly, disc drives may be designed as read-only devices, i.e. devices only capable of reading information from a recorded disc. However, disc drives may also be designed for writing information into the track of a recordable disc.

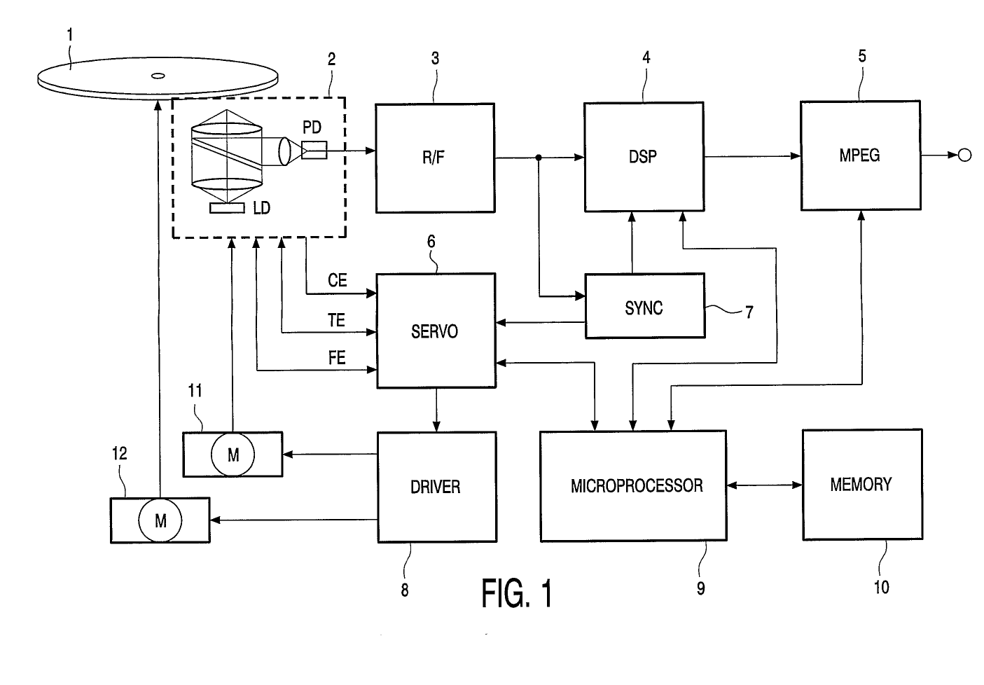

Referring to FIG. 1 of the drawings, an example of a known optical disc player comprises an optical pickup 2 for reproducing signals from an optical disc 1, an RF unit 3 for equalising and shaping the RF signals reproduced from optical disc 1 by pickup 2, and a synchronisation unit 7 for creating a clock signal whose phase is synchronised with the binary data output from the RF unit 3 in order to retrieve digital data using the synchronisation clock, an MPEG decoder 5 for decoding the retrieved digital data to obtain original picture or audio data, and a sledge motor 11 for moving optical pickup 2. The disc player further includes a spindle motor 12 for rotating optical disc 1, a driver for driving the sledge motor 11 and spindle motor 12, and a servo unit 6 for controlling optical pickup 2 and driver 8. A microprocessor 9 supervises overall operations of servo unit 6 and digital signal processing unit 4, and a memory 10 stores data necessary for microprocessor 9.

Physically, the information bearing portion of an optical disc is a series of pits, or bumps, arranged to form a spiral track. Data is encoded in the length of the individual pits and of the space between pits. A laser beam reflected from the optical disc is modulated by the pits and spaces, and received by a detector which produces a similarly modulated electrical signal, or track data signal.

Generally, ill an optical data storage system, as an optical disc is rotated, a signal surface on which the information signal is recorded is subject to a certain amount of vertical movement, dependent on machining accuracy, rotation accuracy, etc. In order to precisely read the information signal, the system is typically provided with a focussing function arranged and configured to maintain the distance between the objective lens (which focuses the light beam from a light source on a target) and the information storage medium constant. In other words, a focus servo system is used which drives the objective lens to compensate for the vertical movement of the signal surface so that the objective lens always accurately focuses a laser beam on the signal surface.

In addition, a known type of optical storage system is provided with a tracking function for causing the focused light spot to target track on the information storage medium. The tracking function is accomplished whereby a detection signal (representing the distance between a target track on the information storage medium and the light spot) is generated corresponding to the light beam reflected from the information storage medium. The detection signal is converted into a digital signal by an A/D converter. Corresponding to the digital signal, the objective lens is driven by a digital servo system. Quality, i.e. robustness of the error signals, is reduced as tilt increases. Generally, the sensitivity of error signals to tilt is lower than the sensitivity of the signals required for address readout.

In summary, therefore, recording and playback devices for optical information carriers have servo control circuits in order to compensate for deviations or errors such as tracking, radial and/or focus errors, the error signals being derived from measured values of an optical scanning unit and processed in a servo unit to form control signals and these control signals being fed to the actuators of the optical scanning unit.

A conventional method of recording data onto an optical disc will now be briefly described. The memory 10 in the arrangement described above with reference to FIG. 1 of the drawings is also known as a temporal memory which may, for example, comprise a DRAM and serves (among other things) to hold compressed data to be recorded on an optical disc 1. Thus, starting from sector address A, consider the case where data is to be recorded onto the optical disc up to sector address B. After the recording action from address A to address B, the system enters a so-called pause mode or state at address B, while more compressed data is fed to the temporal memory. In this pause mode, recording is temporarily suspended but the position on the disc where the next recording action should commence is retained. In this pause state, in conventional systems, all servo loops (focus, radial, tilt, PLL's) are active and address information, i.e. the address on the disc at which the laser beam is tracking, is read from the disc. Using the tracking function of the servo control system, based on the difference between the actual address and the desired address (in this case, address B), single track jumps are performed to keep the laser beam or spot at a position just before address B. Once the temporal memory is filled above a certain threshold level, and a new record command is issued to perform a recording action from address B to address C, the system exits the pause mode or state and re-enters the normal mode of operation. Recording is started at address B and stopped at address C, where the pause mode or state is entered once again.

In the system described above, in view of the fact that the spot is circling (or repeatedly jumping back to) a position on the disc just before address B (address B being the starting address for the next recording action), recording can commence very quickly following receipt of the respective command (of the order of 20 ms). However, power dissipation is very high, even during the above-mentioned pause mode, because all of the servo loops and integrated circuits remain active. It will be appreciated by a person skilled in the art that a conventional read/pause mechanism is analogous to the above-described record/pause mechanism.

The issue of power dissipation generally, and its consequences in relation to temperature, is becoming more and more important with respect to optical drives. In some cases, power dissipation and the resultant effect on temperature directly limits system performance. However, in modern drives, advanced thermal management systems are integrated into the drive software in order to cope with increasing power dissipation.

One aspect of thermal management involves the use of a concept known as (reduced) power down state, in which all servo functions (focus, radial, tilt, etc) are switched off. In addition, a number of integrated circuits are put in the power down state. After being in this power down state for a time period T_{pd}, the system can be “woken up” again, i.e. the integrated circuits are returned to their active mode and the servo functions are re-started. During operation of the system, the drive can enter the power down state if no read/record actions are required. As a consequence, the average power dissipation, and therefore temperature, decreases.

A power down state can be used in two cases:
i) during read/record streams with low bit rate. For example, play-back of MP3 files from a DVD disc, wherein the data transfer rate of the drive is much higher than the average required data rate, so the drive is only reading for a fraction of the time;
ii) in the so-called duty-cycle mode (described in detail in the applicant' co-pending application PHNL030054). In this duty-cycle mode (DCM), the drive interrupts the write/read process after a predefined period Ta and then enters the power down state. Of course, the average data transfer rate goes down with a factor of approximately T_{pd}/(Tₐ+T_{pd})×100%.

A conventional power down mechanism will now be described which is used in current data drives during recording. In the DCM referred to above, the power down mode is entered at the end of the recording at address B (i.e. once the system has entered the above-mentioned pause mode or state). After a certain time T_{pd} (with reduced power dissipation), the recording should proceed at address B again and the system should first “wake up” back to the pause mode. In other words, the power down functionality consists of two transitions: 1) enter power down, and 2) leave power down.

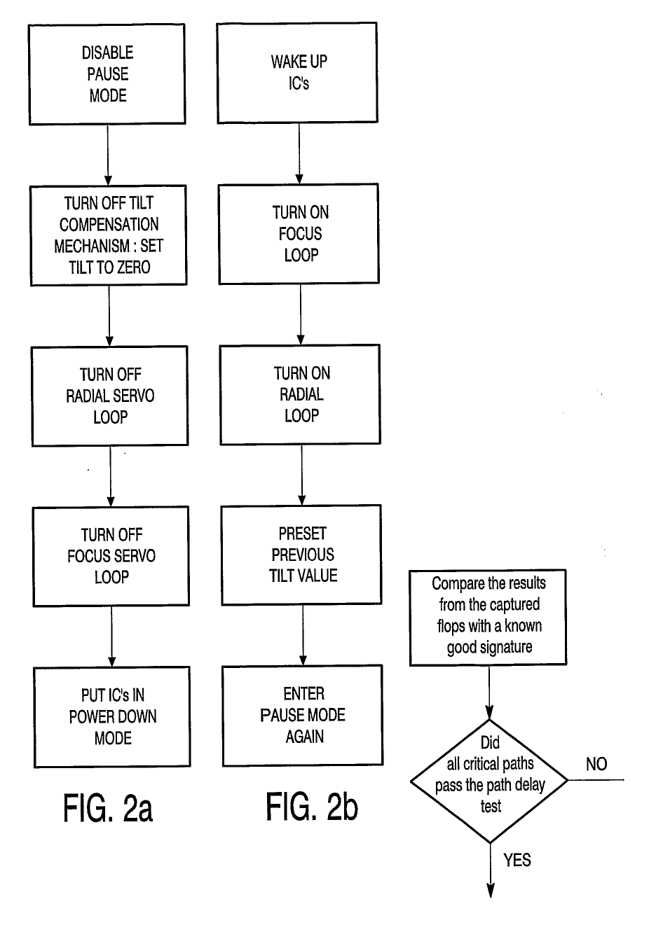

Referring to FIG. 2 of the drawings, the sequence of principal actions involved in both of these transitions is illustrated. Referring to FIG. 2a of the drawing, ‘enter power down’ consists of the following sequence of actions:
a) disable pause mode;
b) turn off tilt compensation mechanism, set tilt to zero;
c) turn off radial servo loop;
d) turn off focus servo loop;
e) turn laser off; and
f) put IC's in power down mode

Similarly, ‘leave power down’ is basically the inverse of the ‘enter power down’ function, and, referring to FIG. 2b of the drawings, consists of the following sequence of actions:
a) wake up IC's;
b) turn laser on;
c) turn on focus loop;
d) turn on radial loop;
e) preset previous tilt value;
f) enter pause mode again (circle before address B).

It is this mechanism which is used in current data drives. It will be appreciated that, upon reception of a write or read command, the drive should react as quickly as possible, so the time taken to ‘leave power down’ is of particular importance. For data storage systems, this requirement is not particularly critical, however, it is a particularly difficult issue with respect to video recorders and the like, because of their real-time requirements. The timing aspects of the DCM described above, and in particular the ‘leave power down’ time, mean that the use of DCM in current audio-visual (AV) products is not practicable: in the ‘leave power down’ the time-consuming focus capture and possible recoveries in the event of failure make the DCM functionality described above impractical for use in AV products and the like.

We have now devised an improved arrangement, and it is an object of the present invention to provide a method and apparatus for effecting a power down function in an optical data drive whereby a reduced power state can be effected, but in which it is possible to “wake up” the system relatively quickly so as to process a newly-received read/record command.

In accordance with the present invention, there is provided a method of reducing power dissipation in an optical drive system between consecutive read/record actions, the system comprising a radiation source, focussing means for directing a radiation spot on a data storage medium at a position thereon at which it is required to perform a read/record action, and a servo control arrangement including at least a tilt compensation mechanism, the method comprising switching off said tilt compensation mechanism and causing said radiation spot to be returned to, or maintained at, substantially the same position on said optical storage medium while said tilt compensation mechanism is inoperative.

Also in accordance with the present invention, there is provided apparatus for reducing power dissipation in an optical drive system between consecutive read/record actions, the system comprising a radiation source, focussing means for directing a radiation spot on a data storage medium at a position thereon at which it is required to perform a read/record action, and a servo control arrangement including at least a tilt compensation mechanism, the apparatus comprising means for switching off said tilt compensation mechanism and means for causing said radiation spot to be returned to, or maintained at, substantially the same position on said optical storage medium while said tilt compensation mechanism is inoperative.

The present invention extends to an optical drive system comprising a radiation source, focussing means for directing a radiation spot on a data storage medium at a position thereon at which it is required to perform a read/record action, a servo control arrangement including at least a tilt compensation mechanism, and apparatus as defined above for reducing power dissipation in the optical drive system between consecutive read/record actions. The invention extends still further to an optical data storage system including an optical drive system as defined above.

In a known optical data drive, in order to readout or record, it is necessary to position an optical spot onto the disc track. The position of the readout spot is determined by the position of an objective lens. Position of the readout spot, and therefore the objective lens, should be done in two directions: focus (from and towards the disc) and in a radial direction, and this is done by moving the objective lens. The objective lens is mounted in an actuator, and this actuator is used to control focus and radial tracking. However, the stroke is limited, and for radial tracking a large stroke is required, so the entire actuator is moved on a sledge which is also controlled in a radial direction with a large stroke. The sledge is also known as the optical pickup unit (OPU), and the laser and photodetector are also mounted on the OPU. Sledge control is typically effected using a sledge stepper motor.

Thus, as will be known to a person skilled in the art, focus tracking is achieved in one step, and radial control is performed in two stages: the fine stage using the actuator and the course stage using the sledge motor. If all of these loops are closed, and the spot is in the correct position on the track, it is said that the system is tracking.

Radial tilt control, on the other hand, is typically a separate loop and, in most known systems, this radial tilt control is part of the actuator. In previous optical recording arrangements, the actuator would generally comprise a two-dimensional actuator (i.e. without tilt control). However, in modern drives, three-dimensional actuators are known which control focus, (fine) radial and tilt. The tilt compensation brach of this control particularly consumes a lot of power.

Thus, the present invention overcomes the above-mentioned problems associated with the prior art by enabling at least the tilt compensation mechanism to be switched off, while ensuring that the spot position is maintained.

In one exemplary embodiment, irrespective of the other functions provided by the servo control arrangement, only the (radial) tilt compensation mechanism may be switched off in order to reduce power dissipation between consecutive read/record actions. However, in principle at least, any mechanism which does not affect the focus and radial tracking of the disc can be switched off between successive read/record actions. For example, in principle, an actuator could be provided which compensates for both radial tilt and tangential tilt, in which case, both tilt values could be set to zero between successive read/record actions. The means for switching the tilt compensation mechanism (and any other mechanism, where applicable) off may preferably be incorporated in a microprocessor which controls the other compensation mechanisms provided by the servo control arrangement.

The position on the optical storage medium at which the radiation spot is maintained, or to which the radiation spot is returned, beneficially corresponds to an address on the optical storage medium at which a previous read/record action was terminated.

The optical drive system beneficially comprises an optical pickup unit including the radiation source and focussing means, an actuator mounted in or on the optical pickup unit for performing fine radial control thereof, and a sledge motor for controlling movement of the optical pickup unit arid performing course radial control thereof, the apparatus beneficially comprising means for disabling the sledge motor function, preferably after the tilt compensation mechanism has been switched off.

In a preferred embodiment, the radiation spot is maintained at, or returned to, the same position on the optical storage medium using the radial actuator voltage, and more preferably, an average radial actuator voltage measurement. Thus, in a preferred method, before the tilt compensation mechanism is switched off, the average radial actuator voltage is read and set as a reference. Once the tilt compensation mechanism has been switched off, the average radial actuator voltage is read again, one or more times, and preferably periodically. If the value of the read average radial actuator voltage is greater than the reference, the radiation spot is beneficially caused to jump back by one track.

These and other aspects of the present invention will be apparent from, and elucidated with reference to the embodiment described herein.

An embodiment of the present invention will now be described by way of example only and with reference to the accompanying drawings, in which:

FIG. 1 is a schematic diagram illustrating a typical optical data drive;

FIG. 2a is a schematic flow diagram illustrating the principal sequence of actions forming an ‘enter power down’ function according to a prior art method;

FIG. 2b is a schematic flow diagram illustrating the principal sequence of actions forming a ‘leave power down’ function according to a prior art method;

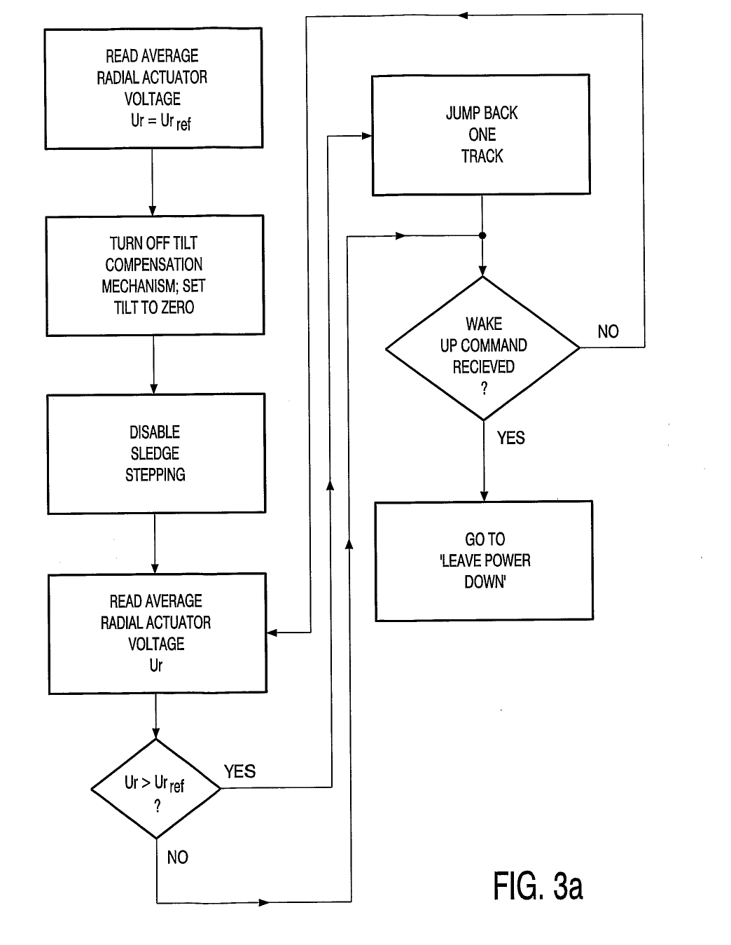

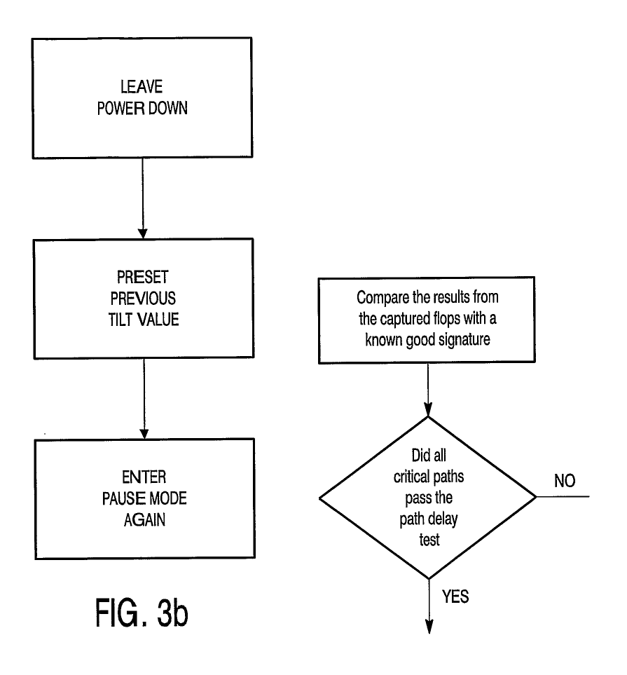

FIG. 3a is a schematic flow diagram illustrating the principal sequence of actions forming an “enter power down” function according to an exemplary embodiment of the present invention; and

FIG. 3b is a schematic flow diagram illustrating the principal sequence of actions forming a “leave power down” function according to an exemplary embodiment of the present invention.

As explained above, in a known optical data drive, in order to readout or record, it is necessary to position an optical spot onto the disc track. The position of the readout spot is determined by the position of an objective lens. Position of the readout spot, and therefore the objective lens, should be done in two directions: focus (from and towards the disc) and in a radial direction, and this is done by moving the objective lens. The objective lens is mounted in an actuator, and this actuator is used to control focus and radial tracking. However, the stroke is limited, and for radial tracking a large stroke is required, so the entire actuator is moved on a sledge which is also controlled in a radial direction with a large stroke. The sledge is also known as the optical pickup unit (OPU), and the laser and photodetector are also mounted on the OPU. Sledge control is typically effected using a sledge stepper motor.

Thus, as will be known to a person skilled in the art, focus tracking is achieved in one step, and radial control is performed in two stages: the fine stage using the actuator and the course stage using the sledge motor. If all of these loops are closed, and the spot is in the correct position on the track, it is said that the system is tracking.

Radial tilt control, on the other hand, is typically a separate loop and, in most known systems, this radial tilt control is part of the actuator. In previous optical recording arrangements, the actuator would generally comprise a two-dimensional actuator (i.e. without tilt control). However, in modem drives, three-dimensional actuators are known which control focus, (fine) radial and tilt. The tilt compensation brach of this control particularly consumes a lot of power.

Thus, a typical optical disc drive comprises servo electronics for providing a tracking function (i.e. a focus and radial control loop: x and z positions) and a (radial) tilt compensation function, which provides compensation in respect of rotation around the y-axis. Referring back to FIG. 1, a typical optical drive includes a driver 8 driving a spindle motor 12 to rotate an optical disc 1, and a sledge motor 11 to move an optical pickup 2 in the radial direction. The optical pickup 2 retrieves digital signals recorded on the optical disc 1, and converts the collected beam into electrical signals. The sledge motor 11 moves the optical pickup 2 in a radial direction, and a servo unit 6 controls the vertical and radial position of the optical pickup 2 with reference to focussing and tracking error signals. The tracking error signal (TE) Uses a low frequency component of the output from a photodetector (PD), an RF unit 3 equalises and shapes analogue high-frequency signals reproduced by the optical pickup 2, and a digital signal processing unit 4 processes binary data output from RF unit 3. A microprocessor 9 supervises the overall operation of each component.

It is known to provide apparatus for effecting tracking control and for performing accurate track j -ump operations when such tracking control has been temporarily suspended (to enable the track jump operation to be effected). For example, U.S. Pat. No. 6,552,973 B1 describes a servo control apparatus for an optical disc drive in which an amount of disc eccentricity is measured, and a compensation value corresponding to the measured disc eccentricity is calculated and stored. The stored compensation value is used in a track search mode so that a more stable and precise track search operation is achieved despite disc eccentricity or tilt caused by imperfect manufacturing processes and disc clamping errors. If a track jump operation is requested, the number of tracks to be crossed between the current and destination tracks is calculated, adjusted in accordance with the above-mentioned compensation value, and a jump pulse is then applied to the tracking actuator installed in the optical pickup so that the laser beam spot can move from the current track to the destination track along some predetermined trajectory. While the track jump operation is conducted, a traverse counter counts the number of the number of traverse signals, which are binary signals generated from the high-frequency signals retrieved by the optical pickup 2. Receiving the counted number of the traverse signals, the microprocessor 9 controls the servo unit 6 so that the tracking actuator stops exactly at the destination track after jumping the calculated number of tracks. Completing the jump operation, the microprocessor 9 resumes retrieval of data from the destination track. In the meantime, if a pause command is received, the inward track jump operation is carried out each time the disc rotates one revolution. The jump start point is controlled by varying the reference level, which enables the track-following control to resume, starting from the original position.

However, in the arrangement of U.S. Pat. No. 6,552,973 B1, the track-following control is temporarily suspended in response to a track jump command, but it is not actually switched off, so there is no resultant reduction in power dissipation. Furthermore, there is no provision made in the described arrangement for reducing power dissipation during suitable periods or modes of operation, contrary to the object of the present invention.

U.S. Pat. No. 6,496,456 B2 describes an optical disc drive system in which, when the temporal memory 10 holding compressed data to be written onto an optical disc 1 reaches a full level, the data is written to the optical disc in a write mode until the memory 10 is empty. A controller the-n prohibits the writing of data on the optical disc 1 and, at the same time, enters a power save mode while further compressed data is transferred into the memory 10. When the amount of data stored in the memory 10 reaches a reference level, the controller switches the system from the power save mode to a normal power supply, and moves the pickup 2 to start writing data on the optical disc 1 until the memory 10 is empty once again. The power save mode is effected by turning off the focus and tracking controls and, optionally, the laser. In addition, the address of the next sector of the optical disc 1 to be written to is stored. Power saving is achieved by cutting the supply of power to all components of the record/playback servo circuit, the focus error signal generator, the tracking error signal generator, the equaliser, the PLL, the speed control signal generator, the laser power controller, the focus controller, the tracking controller, the traverse controller, the spindle motor controller, the focus circuit, the tracking circuit and the laser. This allows power consumption to be significantly lowered relative to the normal power supply mode. However, when the supply of power is resumed to turn on the focus control and the tracking control in that sequence, the tracking controller causes the pickup 2 to seek one of the track turns of the optical disc 1 having a sector whose address is stored, and kicks the pickup 2 cyclically until the sector reaches the pickup 2. Thus, when the system is switched from the power save mode to the normal power supply mode, a significant amount of time elapses before a write or read command can be effectively performed, largely because of the time-consuming focus capture and possible recoveries if it fails, making this method of power saving unsuitable for real-time applications such as audio-visual products and the like.

The present invention intends to define a power down state with a guaranteed ‘leave power down’ timing. In order to meet these timing requirements, when the controller switches the system from a normal power supply mode to a power save mode, the focus and radial servo loops are kept closed, and only the tilt is reduced to zero, i.e. the tilt compensation mechanism is temporarily disabled. Of course, the resultant reduction in power is now limited to that dissipated in the tilt compensation mechanism, which is less that the power saving in conventional power down functions such as that described above. However, in audio-visual applications particularly, the tilt compensation branch of the servo control is one of the most dominant factors in power dissipation, in the sense that power dissipation in the tilt compensation branch is very high, especially with respect to discs having a relatively high tilt value. Another consideration is the fact that playing back, for example, MP3 files from DVD's can cause the system to remain in the pause mode for a relatively long time.

In order to ensure a relatively speedy commencement of a read/record operation from the power down mode of the present invention (and to avoid drifting away from the readout spot to the outer radius of the disc), it is proposed in this exemplary embodiment of the present invention to jump back a track every time the laser beam spot approaches the sector address at which the pause mode was initiated. However, address readout is unreliable because the tilt compensation mechanism is switched off. Thus, a proposed solution provided hereby is to disable the sledge motor controller and use the average radial actuator voltage (i.e. the average voltage applied to the radial actuator controlled by the radial servo loop), to determine when to jump back. Thus, an address readout function is no longer required.

Referring to FIG. 3a of the drawings, the ‘enter power down’ sequence of an exemplary embodiment of the present invention comprises:
a) read average radial actuator voltage Ur, set Ur_{ref}=Ur;
b) turn off tilt compensation mechanism; set tilt to zero;
c) disable sledge stepping;
d) read average radial actuator voltage Ur;
e) If Ur>Ur_{ref} then jump back one track;
f) no wake up command received, then goto d) else goto ‘leave power down’.

The corresponding ‘leave power down’ sequence comprises, referring to FIG. 3b of the drawings:
a) preset previous tilt value;
b) enter (conventional) pause mode (based on address readout)

This ‘leave power down’ sequence is obviously much faster than the original power down sequence and it can be safely used in systems with significant real time requirements, such as audio-visual (AV) drives. It will be appreciated that, instead of performing the above-mentioned process of jumping back tracks, it is possible to simply open the radial loop, but this would lead to excessive power dissipation and noise due to radial-to-focus crosstalk (i.e. whereby radial track crossings are observed in the focus error signal and act as a disturbance in the focus control loop).

The present invention provides a power down state with a reduced tilt and, therefore, decreased power dissipation. The power down state can be brought back to a pause mode at the correct address (which is a precondition for the next read/record action) very quickly. The need for address readout is avoided by using the average radial actuator voltage to initiate track jumps.

In summary, therefore, power dissipation is an important issue in optical drives. Modem optical data drives are equipped with a power down function. Within such a power down state, power dissipation is very low but no read/record action is possible. In order to start a new read/record command, the drive is first required to “wake up”, which can take a considerable amount of time in prior art arrangements (where it is required to enable drivers, initialise the servo, etc). For data drives, this wake up time does not tend to be a significant issue, but for real time applications such as video recorders and the like, it is. Conventional data-drive power down mechanisms are not generally used in, for example, AV drives because they do not meet the fairly strict real-time requirements. Thus, the present invention provides a method and apparatus for effecting a reduced power state in an optical drive, which can then “wake up” to process a newly-received read/record command relatively very quickly. In this reduced power down state, as described above, only the tilt mechanism is switched off. Unreliable address readout (due to the lack of tilt compensation) is avoided by using the average radial actuator voltage to initiate the single track jumps which are required to keep the spot at the required fixed position.

The present invention is particularly suitable for use in, among others, applications such as DVD or Blu-ray disc (BD) video players, as well as other optical disc devices with significant real-time requirements and considerations.

An embodiment of the present invention has been described above by way of example only, and it will be apparent to a person skilled in the art that modifications and variations can be made to the described embodiment without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. In a device claim enumerating several means, several of these means can be embodied by one and the same item of hardware. The mere fact that measures are recited in mutually different independent claims does not indicate that a combination of these measures cannot be used to advantage.

1. Apparatus for reducing power dissipation in an optical drive system between consecutive read/record actions, the system comprising a radiation source, focussing means for directing a radiation spot on a data storage medium (1) at a position thereon at which it is required to perform a read/record action, and a servo control arrangement (6) including at least a tilt compensation mechanism, the apparatus comprising means for switching off said tilt compensation mechanism and means for causing said radiation spot to be returned to, or maintained at, substantially the same position on said optical storage medium (1) while said tilt compensation mechanism is inoperative.

2. Apparatus according to claim 1, wherein said servo control arrangement (6) includes a plurality of compensation mechanisms, including focus and radial tracking functions, and any one or more of said compensation mechanisms, except said focus and radial tracking functions, is switched off in order to reduce power dissipation between consecutive read/record actions.

3. Apparatus according to claim 1, wherein the position on the optical storage medium (1) at which the radiation spot is maintained, or to which the radiation spot is returned, beneficially corresponds to an address on the optical storage medium (1) at which a previous read/record action was terminated.

4. An optical drive system comprising a radiation source, focussing means for directing a radiation spot on a data storage medium (1) at a position thereon at which it is required to perform a read/record action, a sero control arrangement (6) including at least a tilt compensation mechanism, and apparatus according to claim 1.

5. An optical drive system according to claim 4, further comprising an optical pickup unit (2) including the radiation source and focussing means, and a sledge motor for controlling movement of the optical pickup unit in a radial direction relative to the optical storage medium (1), the apparatus comprising means for disabling the sledge motor function.

6. An optical drive system according to claim 5, wherein the sledge motor function is disabled.

7. An optical drive system according to claim 4, wherein the radiation spot is maintained at, or returned to, the same position on the optical storage medium (1) using a radial actuator voltage measurement.

8. An optical drive system according to claim 7, wherein the radiation spot is maintained at, or returned to, the same position on the optical storage medium (1) using an average radial actuator voltage measurement.

9. An optical drive system according to claim 8, arranged and configured such that, before the tilt compensation mechanism is switched off, the average radial actuator voltage is read and set as a reference, and once the tilt compensation mechanism has been switched off, the average radial actuator voltage is read again, one or more times, and if the value of the read average radial actuator voltage has an absolute difference greater than some predetermined threshold relative to said reference, the radiation spot is caused to jump back by one track on said optical storage medium (1).

10. An optical data storage system including an optical drive system according to claim 4.

11. A method of reducing power dissipation in an optical drive system between consecutive read/record actions, the system comprising a radiation source, focussing means for directing a radiation spot on a data storage medium (1) at a position thereon at which it is required to perform a read/record action, and a servo control arrangement (6) including at least a tilt compensation mechanism, the method comprising switching off said tilt compensation mechanism and causing said radiation spot to be returned to, or maintained at, substantially the same position on said optical storage medium (1) while said tilt compensation mechanism is inoperative.
